(19) United States
(12) Patent Application Publication
(10) Pub. No.: US 2006/0188661 A1
(43) Pub. Date: Aug. 24, 2006

(54) Method of forming film pattern, method of manufacturing device, electro-optical device, and electronic apparatus

(75) Inventors: Toshimitsu Hirai, Chino (JP); Katsuyuki Moriya, Azumino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/351,210

(22) Filed: Feb. 9, 2006

(30) Foreign Application Priority Data
Feb. 23, 2005 (JP) 2005-046600
Oct. 19, 2005 (JP) 2005-304020

(51) Int. Cl. H05H 1/00

(52) U.S. Cl. 427/533; 427/256

(57) ABSTRACT

A method of forming a film pattern by arranging a functional liquid on a substrate includes; forming first banks having a lyophobic property on surfaces thereof; arranging a first functional liquid in regions partitioned by the first banks; baking the first functional liquid; forming second banks on the first banks; and arranging a second functional liquid in regions partitioned by the second banks. A lyophilic treatment is performed on the surfaces of the first banks between the arranging of the first functional liquid and the forming of the second banks.

### BACKGROUND

1. Technical Field

The present invention relates to a method of forming a film pattern, to a method of manufacturing a device, to an electro-optical device, and to an electronic apparatus.

2. Related Art

Devices having wiring lines, such as electronic circuits or integrated circuits, are manufactured by using a photolithography method, for example. The photolithography method forms a thin wiring pattern by applying a photosensitive material, which is called a resist, on a substrate on which a conductive film is previously applied, by radiating rays onto the circuit pattern and developing the circuit pattern, and by etching the conductive film according to a resist pattern. However, the photolithography method requires large equipments, such as a vacuum apparatus, or a complicated process, and only a small percentage of the materials are used, causing a high manufacturing cost and a waste of materials.

On the other hand, there has been suggested a method of forming a wiring pattern on a substrate by using a liquid droplet discharging method in which a liquid material is discharged from a liquid droplet discharging head in the shape of liquid droplets, that is, a so-called inkjet method (for example, see JP-A-11-271753). In this method, ink for forming the wiring pattern, which is a functional liquid having conductive particles, such as metal particles, dispersed therein is directly applied on the substrate in a pattern, and then a heat treatment or laser radiation is performed on the ink to convert the ink into a thin conductive film pattern. Since this liquid charging method does not need a photolithography technique, this method has the advantages of a simple manufacturing process and a reduction in the amount of raw material used.

When a film pattern is formed on a substrate by using the inkjet method, an embankment structure called a bank is typically formed in order to prevent ink from spreading. The surfaces of the banks are subjected to a lyophobic treatment in order to prevent the ink from adhering to the surfaces of the banks. However, the banks having a lyophobic property cause the wettability of the ink discharged on the banks to be deteriorated when another pattern is formed on the banks, resulting in a poor pattern.

### SUMMARY

An advantage of some aspects of the invention is that it provides a method of forming a film pattern capable of uniformly forming a fine, thin film pattern with high accuracy, a method of manufacturing a device, an electro-optical device, and an electronic apparatus.

According to an aspect of the invention, a method of forming a film pattern by arranging a functional liquid on a substrate includes; forming first banks having a lyophobic property on surfaces thereof; arranging a first functional liquid in regions partitioned by the first banks; baking the first functional liquid; forming second banks on the first banks; and arranging a second functional liquid in regions partitioned by the second banks. A lyophilic treatment is performed on the surfaces of the first banks between the arranging of the first functional liquid and the forming of the second banks.

According to this manufacturing method of this aspect, since a lyophilic treatment is performed on the first banks of a lower layer before the second functional liquid is arranged, it is possible to improve wettability between the substrate and the second functional liquid, and thus to form a uniform film pattern.

In this aspect, it is preferable that the lyophilic treatment include radiating plasma onto the first banks under an atmosphere containing oxygen, radiating ultraviolet rays onto the first banks, a heat treatment on the first banks, and combinations thereof.

Further, in this aspect, it is preferable that the functional liquids have conductivity by a thermal or optical treatment. For example, the functional liquids may contain conductive minute particles.

According to the manufacturing method of this aspect, it is possible to use the film pattern as a wiring pattern, and thus this method can be applied to various devices. In addition, when a material forming a light-emitting element, such as an organic EL element, or R, G, and B ink materials are used instead of conductive minute particles and an organic silver compound, the manufacturing method of this aspect can be applied to manufacture an organic EL device or a liquid crystal display device having color filters therein.

Further, according to another aspect of the invention, a method of manufacturing a device includes forming a film pattern on a substrate by using the above-mentioned film pattern forming method.

According to this aspect, it is possible to achieve a device having a multi-layer film pattern which closely adheres to a substrate and has a uniform thickness.

Furthermore, according to still another aspect of the invention, an electro-optical device includes a device manufactured by the above-mentioned device manufacturing method. In addition, according to yet another aspect of the invention, an electronic apparatus includes the above-mentioned electro-optical device.

According to these aspects, it is possible to achieve an electro-optical device and an electronic apparatus each having a multi-layer film pattern which closely adheres to a substrate and has a uniform thickness.

### BRIEF DESCRIPTION OF THE DRAWINGS

The invention will be described with reference to the accompanying drawings, wherein like numbers reference like elements.

FIG. 1 is a cross-sectional view conceptually illustrating a method of forming a film pattern according to an embodiment of the invention.

FIG. 2 is an enlarged view illustrating a portion of an active matrix substrate.

FIG. 3 is an equivalent circuit diagram of the active matrix substrate.

FIGS. 4A and 4B are diagrams illustrating a process of forming the active matrix substrate.

FIGS. 5A and 5B are diagrams illustrating a process subsequent to the process shown in FIGS. 4A and 4B.

FIG. 6 is a perspective view schematically illustrating a liquid droplet discharging device.

FIG. 7 is a cross-sectional view of the liquid droplet discharging head.

FIGS. 8A to 8B are diagrams illustrating a process subsequent to the process shown in FIGS. 5A and 5B.

FIGS. 9A to 9C are diagrams illustrating a process subsequent to the process shown in FIGS. 8A and 8B.

FIGS. 10A to 10C are diagrams illustrating a process subsequent to the process shown in FIGS. 9A to 9C.

FIGS. 11A to 11C are diagrams illustrating a process subsequent to the process shown in FIGS. 10A to 10C.

FIGS. 12A to 12C are diagrams illustrating a process subsequent to the process shown in FIGS. 11A to 11C.

FIGS. 13A to 13C are diagrams illustrating a process subsequent to the process shown in FIGS. 12A to 12C.

FIGS. 14A to 14C are diagrams illustrating a process subsequent to the process shown in FIGS. 13A to 13C.

FIGS. 15A to 15C are diagrams illustrating a process subsequent to the process shown in FIGS. 14A to 14C.

FIGS. 16A to 16C are diagrams schematically illustrating another active matrix substrate.

FIG. 17 is a plan view of a liquid crystal display device as viewed from a counter substrate.

FIG. 18 is a cross-sectional view of the liquid crystal display device.

FIGS. 19A to 19C are diagrams illustrating examples of an electronic apparatus of the invention.

### DESCRIPTION OF EXEMPLARY EMBODIMENTS

Hereinafter, exemplary embodiments of the invention will be described with reference to the accompanying drawings.

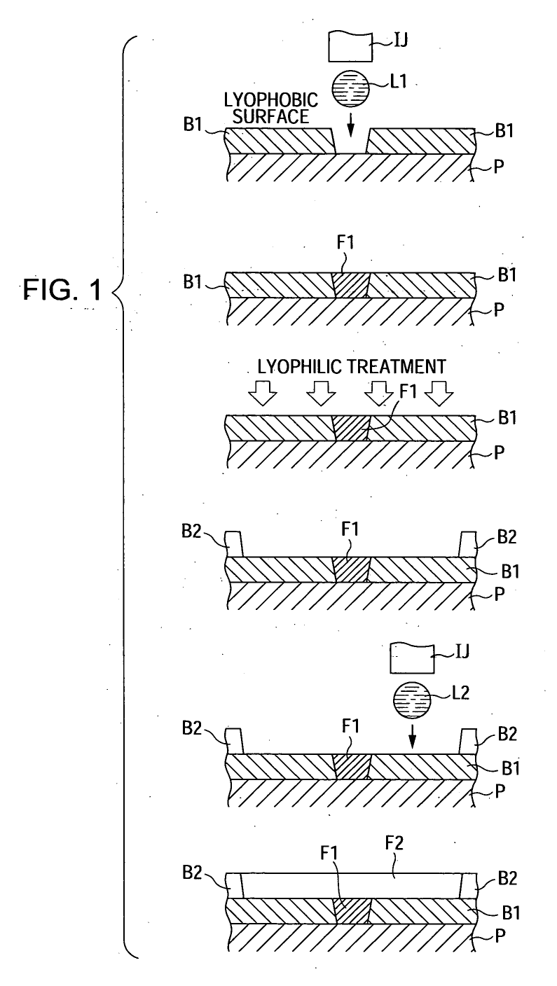

FIG. 1 is a diagram conceptually illustrating a method of forming a film pattern according to the invention.

The method of forming a film pattern according to this invention includes a process of forming first banks B1 on a substrate P, a process of arranging a first functional liquid L1 in regions partitioned by the first banks B1, a process of drying (baking) the first functional liquid L1 to form a first film pattern F1, a process of forming second banks B2 on the first banks B1, a process of arranging a second functional liquid L2 in regions partitioned by the second banks B2, a process of drying (baking) the second functional liquid L2 to form a second film pattern F2.

In the method of forming the film pattern according to the invention, the functional liquids are arranged in the regions partitioned by the first and second banks B1 and B2, and the functional liquids are dried to form the film patterns F1 and F2 on the substrate P. In this case, since the shapes of the film patterns are defined by the banks, the banks B1 and B2 are formed such that adjacent banks are arranged at narrow pitches which results in fine, thin film patterns F1 and F2.

The banks can be formed by, for example, a lithography method or a printing method. For example, if the lithography method is used, a material forming the banks is coated onto the substrate P to form a film by a predetermined method, such as a spin coating method, a spray coating method, a roll coating method, a dye coating method, or a dip coating method, and the film is patterned by, for example, etching or ashing, thereby forming banks having a predetermined pattern. Alternatively, banks may be formed on a member other than the substrate P, and then arranged on the substrate P.

It is preferable that the surfaces of the banks B1 and B2 have a lyophobic property. This makes it possible to prevent a functional liquid from adhering to the upper surfaces of the banks and to accurately form the film pattern in a desired shape. However, for example, when the second film pattern F2 is formed on the banks B1, the banks B1 having the lyophobic surfaces deteriorate the wettability of the second functional liquid L2 in the places where the lyophobic banks B1 are used as a base layer, which results in a poor film pattern F2. Therefore, in this embodiment, a process of performing a lyophilic treatment on the surfaces of the banks B1 is executed between the process of arranging the first functional liquid L1 and the process of forming the second banks B2. The lyophilic treatment includes ultraviolet radiation, O₂ plasma processing using oxygen as a raw gas in atmosphere (that is, plasma is radiated onto the first banks B1 under atmosphere including oxygen), a thermal treatment, and a combination thereof.

A method of making the banks lyophobic includes a method of performing plasma processing (lyophobic treatment) on the surfaces of the banks using gas including fluorine, a method of forming the banks with a lyophobic material (a material containing a lyophobic ingredient, such as a fluorine group). However, when the banks B2 are formed on the upper layer (that is, the bank material is patterned into a bank shape) and then plasma processing is performed on the banks, the lyophobic treatment is performed on the lyophilic banks B1 of the lower layer. In this case, sufficient wettability may not be ensured when the functional liquid L2 is discharged and arranged. Thus, it is preferable that the banks B2 of the upper layer be formed of a lyophobic material. Alternatively, the following method may be used to form the lyophobic banks: a thin film is formed of a material forming the banks; a lyophobic treatment is performed on the surface of the thin film; and then patterning is performed thereon. In this case, since the lyophobic treatment is performed before the patterning, the banks B1 of the lower layer can keep the lyophilic property. In addition, since the lyophobic treatment is not performed on the side surfaces of the banks B2, good wettability is obtained between the side surfaces of the banks and the functional liquid L2.

Various kinds of functional liquids can be used as the functional liquids (ink) L1 and L2 of the invention. The functional liquid refers to a solution capable of forming a film (functional film) having a predetermined function by making film components contained in liquid formed as a film. As the predetermined function, there are various functions, such as electrical and electronic functions (for example, conductivity, insulation, piezoelectricity, superconductivity, and dielectricity), an optical function (for example, photoselective absorption, reflectivity, polarization, photoselective transmitivity, non-linear optical property, luminescence, such as fluorescence or phosphorescence, and photochromic property), a magnetic function (for example, hard magnetism, soft magnetism, non-magnetism, and magnetic permeability), a chemical function (for example, adsorption, desorption, catalyst, suction, ion conductivity, oxidation-reduction, electro-chemical property, and electrochromic property), a mechanical function (for example, abrasion resistance), a thermal function (for example, heat conductivity, thermal isolation, and infrared radioactivity), a biological function (for example, bio-compatibility and anti-thrombosis). For example, ink exhibiting conductivity by a thermal treatment or optical treatment is used as the functional liquids L1 and L2 to form a film pattern having conductivity. This conductive film pattern can be applied to various devices as wiring lines.

The functional liquids can be arranged in the regions partitioned by the bahks by using a liquid droplet discharging method, that is, a so-called inkjet method. The liquid droplet discharging method has advantages over other applying methods, such as a sputtering method that a waste of liquid materials is prevented and the amount of the functional liquids arranged on the substrate and the position thereof are easily controlled.

In FIG. 1, two film patterns F1 and F2 are sequentially formed. However, three or more film patterns may be formed by the above-mentioned method. That is, a lyophilic treatment may be performed on the banks in the lower layer before a film pattern is formed on the upper layer to improve wettability between the banks and the functional liquid, thereby forming a good film pattern.

Next, as an embodiment of a method of manufacturing a device according to the invention, a description will be made of an example in which the film pattern forming method of the invention is applied to a method of manufacturing an active matrix substrate.

Active Matrix Substrate

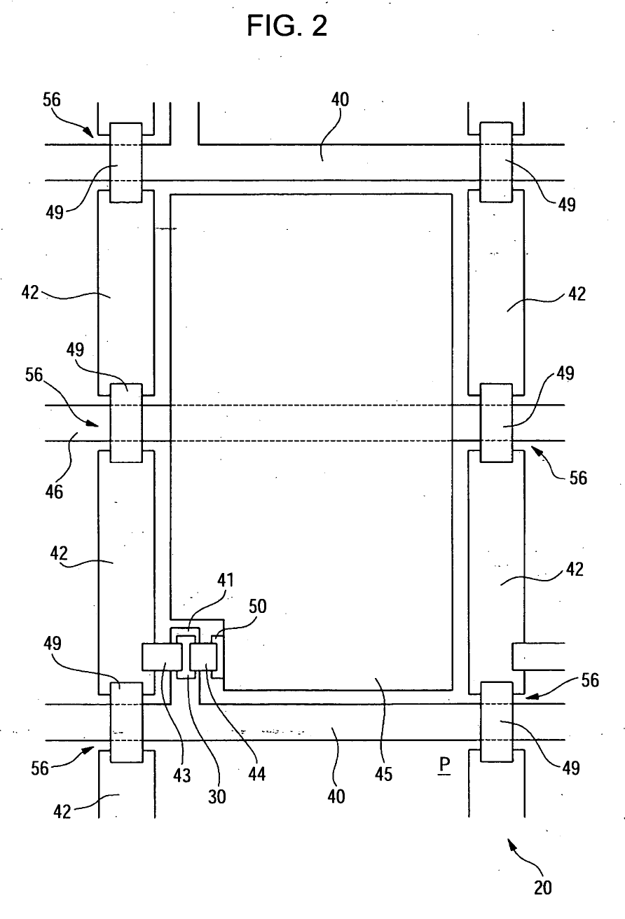

FIG. 2 is an enlarged plan view illustrating a portion of an active matrix substrate according to this embodiment.

Gate lines 40 and the source lines 42 are arranged in a lattice shape on an active matrix substrate 20. That is, a plurality of gate lines 40 is formed so as to extend in an X direction (first direction), and the source lines 42 are formed so as to extend in a Y direction (second direction).

Further, each gate electrode 41 is connected to the gate line 40, and a TFT 30 is arranged on the gate electrode 41 with an insulating film interposed therebetween. In addition, each source electrode 43 is connected to the source line 42, and one end of the source electrode 43 is connected to the TFT (switching element) 30.

Furthermore, each pixel electrode 45 is arranged in a region surrounded by the gate lines 40 and the source lines 42, and is connected to the TFT 30 through a drain electrode 44.

Moreover, capacitor lines 46 are also provided substantially in parallel to the gate lines 40 on the active matrix substrate 20. Each capacitor line 46 is arranged below the pixel electrode 45 and the source line 42 with an insulating film interposed therebetween.

The gate lines 40, the gate electrodes 41, the source lines 42, and the capacitor lines 46 are formed on the same surface.

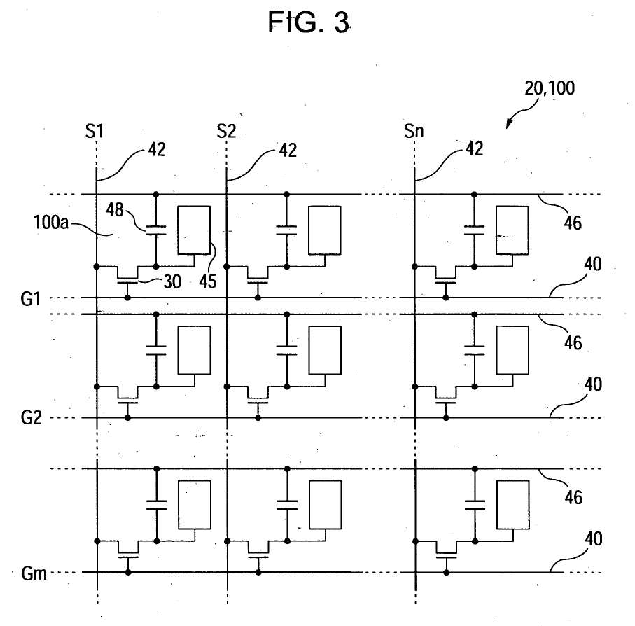

FIG. 3 is an equivalent circuit diagram of the active matrix substrate 20 used for a liquid crystal display device.

When the active matrix substrate 20 is used for a liquid crystal display device, a plurality of pixels 100a are arranged in a matrix in an image display region. The TFT 30 for pixel switching is formed in each of the pixels 100a. The source lines 42 are electrically connected to sources of the TFTs 30 through the source electrodes 43 to supply pixel signals S1, S2, . . . , Sn to the TFTs 30. The pixel signals S1, S2, . . . , Sn may be line-sequentially supplied to the source lines 42 in this order, or they may be supplied to every group of a plurality of adjacent source lines 42.

Further, the gate lines 40 are electrically connected to gates of the TFTs 30 through the gate electrodes 41. Scanning signals G1, G2, . . . , Gm are line-sequentially applied to the gate lines 40 in this order at a predetermined timing in a pulse manner.

Each pixel electrode 45 is electrically connected to a drain of the TFT 30 through the drain electrode 44. When the TFT 30, serving as a switching element, is kept on for a predetermined period, the pixel signal S1, S2, . . . , Sn supplied through the source lines 42 are written onto the corresponding pixels at a predetermined timing. The pixel signals S1, S2, . . . , Sn with predetermined levels which are written to liquid crystal via the pixel electrodes 45 are held for a predetermined period between the pixel electrodes and counter electrodes 121 of a counter substrate 20, as shown in FIG. 18.

In order to prevent the leakage of the held pixel signals S1, S2, . . . , Sn, storage capacitors 48 formed by the capacitor lines 46 are additionally provided parallel to liquid crystal capacitors formed between the pixel electrodes 45 and the counter electrodes 121. For example, the voltage of the pixel electrodes 45 is held by the storage capacitors 48 for a time which is three orders of magnitude longer than that for which a source voltage is applied. This makes it possible to improve a charge holding characteristic and to achieve a liquid crystal display device 100 with a high contrast ratio.

Method of Manufacturing Active Matrix Substrate

Next, a method of manufacturing the active matrix substrate 20 will be described.

The method of manufacturing the active matrix substrate 20 includes a first process of forming wiring lines on the substrate in a lattice pattern, a second process of forming a laminated portion 35, and a third process of forming the pixel electrodes 45.

Hereinafter, each process will be described in detail.

First Process of Forming Wiring Lines

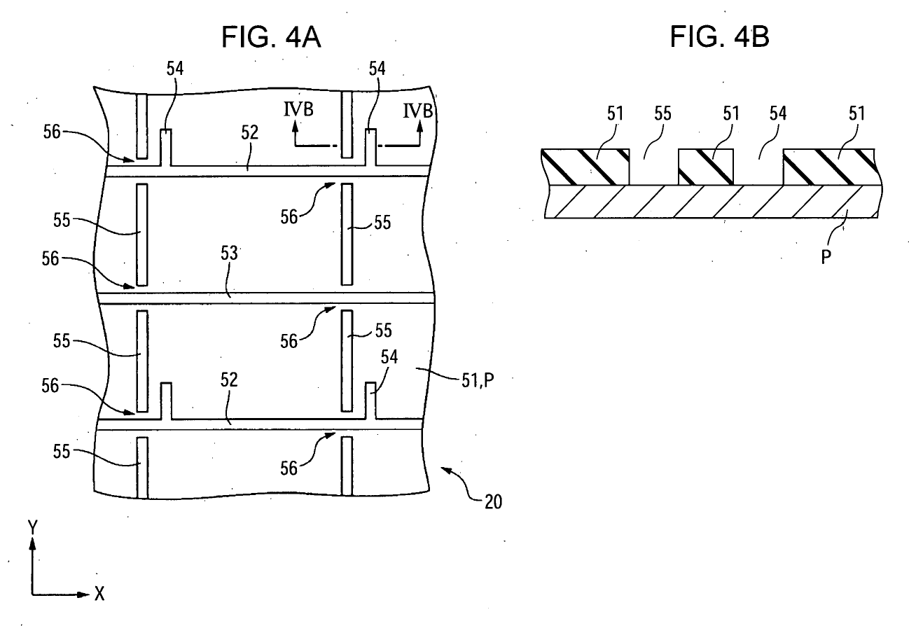

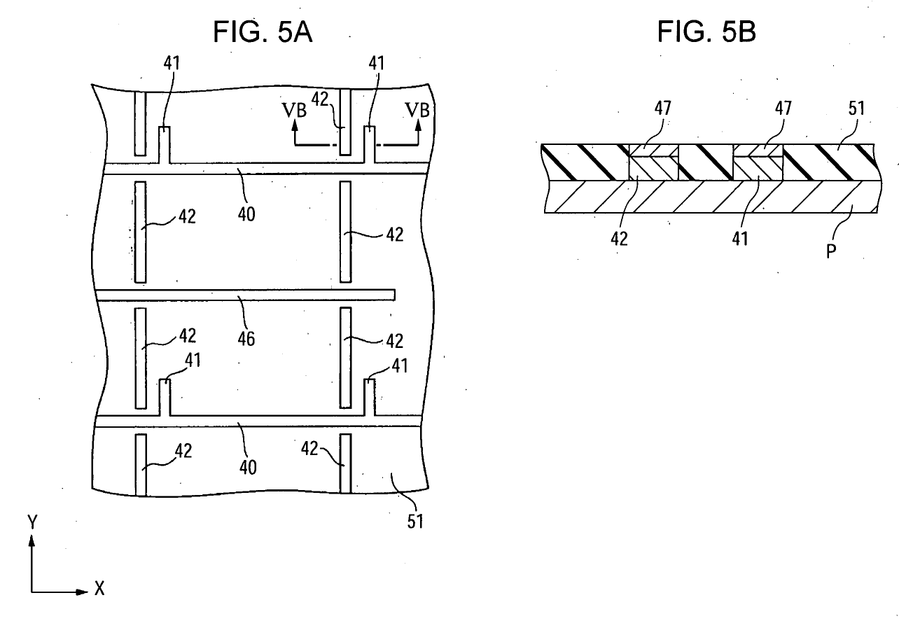

FIGS. 4A and 4B and FIGS. 5A and 5B are diagrams illustrating a wiring line forming process, which is the first process. FIG. 4B is a cross-sectional view taken along the line IVB-IVB of FIG. 4A, and FIG. 5B is a cross-sectional view taken along the line VB-VB of FIG. 5A.

The substrate P on which wiring lines having a lattice pattern, such as the gate lines 40 and the source lines 42, will be formed can be formed of various materials, such as glass, quartz glass, Si wafer, plastic film, and metal film. In addition, for example, a semiconductor film, a metal film, a dielectric film, and an organic film may be formed as base layers on the substrate formed of these materials.

First, as shown in FIGS. 4A and 4B, banks 51 formed of an insulating film are provided on the substrate P. The banks are members for defining the arrangement positions of ink for wiring lines, which will be described later, on the substrate P.

More specifically, as shown in FIG. 4A, the banks 51 having a plurality of openings 52, 53, 54, and 55 are formed on the substrate P subjected to a cleaning process by a photolithography method so as to correspond to the forming positions of the wiring lines having a lattice pattern.

For example, the banks 51 can be formed of a polymer material, such as an acrylic resin, a polyimide resin, an olefin-based resin, or a melamine resin. In addition, considering heat resistance, the banks 51 may be formed of an inorganic material, such as, a high molecular inorganic material or photosensitive inorganic material containing silicon with a skeleton of polysilazane, polysiloxane, siloxane resist, or polysilane resist, a spin-on-glass film containing one of silica glass, alkylsiloxane polymer, alkylsilsequioxane polymer, alkylsilsequioxane polymer hydride and polyaryl ether, a diamond film, or an amorphous carbon fluoride film. In addition, the banks may be formed of an inorganic material, such as aerogel or porous silica. When a photosensitive material, such as a photosensitive polysilazane composition containing polysilazane and a photo-oxidation generating agent is used, a resist mask is not needed, which is preferable. Further, a lyophobic treatment is performed on the banks 51 in order to effectively arrange ink for a wiring pattern into the openings 52, 53, 54, and 55. The lyophobic treatment includes, for example, a CF₄ plasma process (a plasma process using gas which has fluorine ingredients). In addition, instead of the CF₄ plasma process, the banks 51 may be formed of a lyophobic material (for example, a fluorine base).

The openings 52, 53, 54, and 55 formed by the banks 51 correspond to the wiring lines having a lattice pattern, such as the gate lines 40 and the source lines 42. That is, ink for wiring lines is arranged in the openings 52, 53, 54, and 55 of the banks 51 to form wiring lines having a lattice pattern, such as the gate lines 40 and the source lines 42.

More specifically, the openings 52 and 53 formed to extend in the X direction correspond to the forming positions of the gate lines 40 and the capacitor lines 46. The openings 54 corresponding to the forming positions of the gate electrodes 51 are connected to the openings 52 corresponding to the forming positions of the gate lines 40. In addition, the openings 55 formed to extend in the Y direction correspond to the forming positions of the source lines 42. The openings 55 extending in the Y direction are separated from the openings 52 and 53 extending in the X direction at intersections 56 therebetween so as not to intersect the openings 52 and 53.

Next, the ink for wiring lines which contains conductive minute particles is discharged into the openings 52, 53, 54, and 55 by a liquid droplet discharging device IJ, which will be described later, to form wiring lines including, for example, the gate lines 40 and the source lines 42 on the substrate in a lattice pattern.

The ink for wiring lines is composed of a dispersion liquid obtained by dispersing conductive minute particles into a dispersion medium or a solution obtained by dispersing an organo-silver compound or silver oxide nano-particles in a solvent (dispersion medium). In addition, the conductive particles include, for example, particles of metallic materials, such as gold, silver, copper, tin, and plumbum, oxides thereof, and particles of a conductive polymer or a superconductor. An organic material can be coated on the surface of the conductive minute particles in order to improve dispersibility.

It is preferable that the conductive minute particles have a diameter in the range of 1 nm to 0.1 μm. When the diameter of the particle is larger than 0.1 μm, nozzles of a liquid droplet discharging head, which will be described later, may be clogged. On the other hand, when the diameter of the particle is smaller than 0.1 nm, the volume ratio of a coating agent to the conductive minute particle increases, which results in an excessively large percentage of an organic material in a film to be obtained.

Any dispersion medium may be used as long as it can disperse the above-mentioned conductive particles without coagulation. For example, the dispersion media include, in addition to water, alcohols, such as methanol, ethanol, propanol, and butanol; a hydrocarbon-based compound, such as n-heptane, n-octane, decane, dodecane, tetradecane, toluene, xylene, cymene, durene, indene, dipentene, tetrahydronaphthalene, decahydronaphthalene, and cyclohexylbenzene; an ether-based compound, such as ethylene glycol dimethyl ether, ethylene glycol diethyl ether, ethylene glycol methylethyl ether, diethylene glycol dimethyl ether, diethylene glycol diethyl ether, diethylene glycol methylethyl ether, 1,2-dimethoxyethane, bis(2-methoxyethyl) ether, and p-dioxane; and a polar compound, such as propylene carbonate, γ-butyrolactone, N-methyl-2-pyrrolidone, dimethylformamide, dimethylsulfoxide, and cyclohexanone. From the viewpoint of the dispersibility of the minute particles, the stability of the dispersion solution, and easy applicability to a liquid droplet discharging method (an inkjet method), preferably, water, alcohol, the hydrocarbon-based compound, and the ether-based compound are used as the dispersion media. More preferably, water and the hydrocarbon-based compound are used as the dispersion media.

Further, it is preferable that the dispersion solution of the conductive minute particles have a surface tension of 0.02 N/m to 0.07 N/m. In a case in which liquid is discharged by the inkjet method, when the surface tension is smaller than 0.02 N/m, wettability of an ink composition with respect to the nozzle surface is raised so that the discharge direction tends to deviate. On the other hand, when the surface tension exceeds 0.07 N/m, the shape of the meniscus at the top of the nozzle becomes unstable, making it difficult to control the discharge amount and the discharge timing. In order to adjust the surface tension, a good way is to add a small amount of surface tension adjusting agent, such as a fluorine-based, silicon-based, or non-ionic surface tension adjusting agent, into the above-mentioned dispersion solution to an extent not to largely decrease the contact angle with the substrate. The nonionic surface tension adjusting agent improves the wettability of liquid on the substrate and the leveling property of the film, and thus prevents the occurrence of minute unevenness on the film. The above-mentioned surface tension adjusting agent may contain organic compounds, such as alcohol, ether, ester, and ketone, if necessary.

The viscosity of the dispersion solution is preferably in a range of 1 mPa·s to 50 mPa·s. In a case in which a liquid material is discharged in the form of liquid droplets by the inkjet method, if the viscosity is lower than 1 mPa·s, the area around the nozzle is easily contaminated by the discharged ink. On the other hand, if the viscosity is higher than 50 mPa·s, the nozzles are frequently clogged, which makes it difficult to smoothly discharge liquid droplets.

After the ink for wiring lines is discharged onto the substrate P, a drying process and a baking process are performed, if necessary, to remove the dispersion medium.

The drying process can be performed by heating the substrate P using, for example, a normal hot plate or an electric furnace. The drying process is performed under the conditions of, for example, a heating temperature of 180° C. and a heating time of about sixty minutes.

The treatment temperature of the baking process is suitably determined taking into account, for example, the boiling point (vapor pressure) of the diffusion medium, the type and pressure of the atmosphere gas, the thermal characteristics, such as dispersibility and oxidization, of the minute particles, the presence or absence of the coating material and the amount thereof if present, and the heat resistance temperature of the substrate. For example, the baking process should be performed at a temperature of about 250° C. in order to remove the coating agent from the organic material.

The drying and baking processes ensures electrical contact between the conductive minute particles to convert a material film into a conductive film.

Further, a metal protective film 47 may be formed on wiring lines, such as gate lines 40 and the source lines 42. The metal protective film 47 functions to prevent (electron) migration of a conductive film formed of, for example, silver or copper. Preferably, the metal protective film 47 is formed of nickel. The metal protective film 47 formed of nickel is also arranged on the substrate P by the liquid droplet discharging method. Alternatively, nickel may be formed by, for example, electroless deposition.

As shown in FIGS. 5A and 5B, a layer including the banks 51 and wiring lines having a lattice pattern is formed on the substrate P by the above-mentioned processes.

Here, examples of the discharge technology of the liquid droplet discharging method include an electrification control method, a pressure oscillation method, an electromechanical conversion method, a thermoelectric conversion method, and an electrostatic absorption method. The electrification control method imparts charges to a material using an electrification electrode and controls the direction in which the material is scattered using a deflecting electrode so as to discharge the material from the nozzles. The pressure oscillation method applies a super-high pressure of approximately 30 kg/cm² so as to discharge a material from the leading ends of the nozzles. When no control voltage is applied, the material is discharged from the nozzles in a straight line. On the other hand, when a control voltage is applied, electrostatic repulsion occurs between material particles, so that the material is not discharged from the nozzles. The electromechanical conversion method utilizes the property of a piezoelectric element which is deformed when receiving electrical signals in the form of pulses. That is, when the piezoelectric element is deformed, pressure is applied, via a flexible substance, to a space in which a material is stored to press the material out from this space, causing the material to be discharged from the nozzles.

The thermoelectric conversion method rapidly vaporizes the material using a heater provided in the space where the material is stored so as to form bubbles. Then, the material within the space is discharged by the pressure from the bubbles. The electrostatic absorption method applies micro pressure to the space where the material is stored so that a meniscus is formed on the material in the nozzles. In this state, electrostatic attraction is applied to discharge the material. In addition to these methods, technologies, such as a method that utilizes a change in the viscosity of a fluid by an electric field and a method in which the material is scattered by electrical discharge sparks, may also be employed. The liquid discharge method has advantages in that there is little waste in the material used, and in that a desired quantity of material can be accurately placed in a desired position. Note that the quantity of one droplet of the liquid material discharged by the droplet discharge method may be, for example, 1 to 300 nanograms.

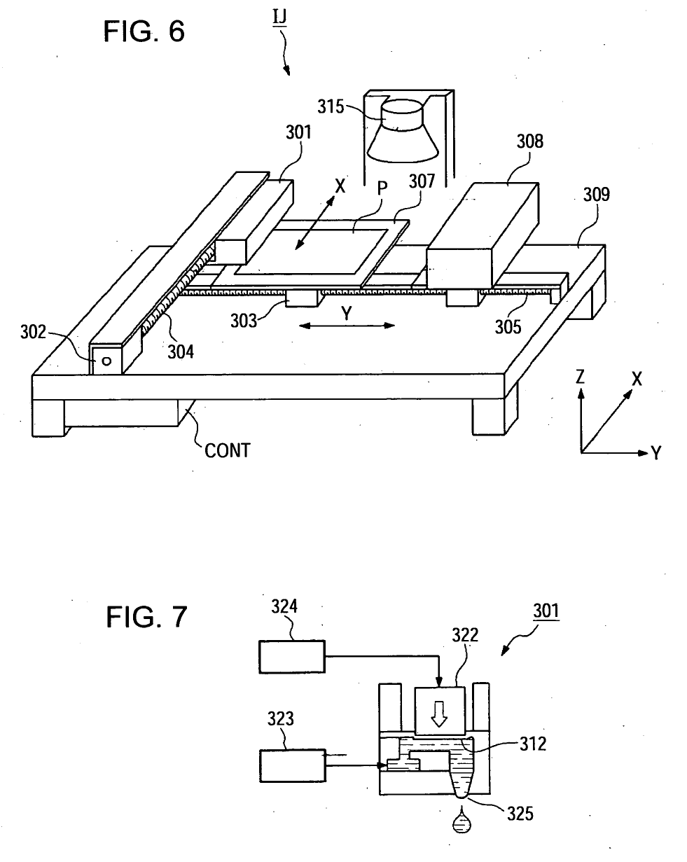

For example, the liquid droplet discharging device IJ shown in FIG. 6 is used to form the wiring lines having a lattice pattern.

The liquid droplet discharging device (inkjet device) IJ discharges (drops) liquid droplets from a liquid droplet discharging head onto the substrate P, and includes a liquid droplet discharging head 301, an X-axis-direction driving shaft 304, a Y-axis-direction guide shaft 305, a control device CONT, a stage 307, a cleaning mechanism 308, a table 309, and a heater 315. The stage 307 supports the substrate P having the ink (liquid material) discharged thereon by the liquid droplet discharging device IJ, and includes a fixing mechanism (not shown) for fixing the substrate P to a reference position.

The liquid droplet discharging head 301 is a multi-nozzle-type liquid droplet discharging head having a plurality of discharging nozzles, and a longitudinal direction thereof is the Y-axis direction. The plurality of discharging nozzles are provided in the lower surface of the liquid droplet discharging head 301 so as to extend in the Y-axis direction at predetermined intervals. The ink containing the conductive minute particles is discharged from the discharging nozzles of the liquid droplet discharging head 301 onto the substrate P supported by the stage 307.

An X-axis-direction driving motor 302 is connected to the X-axis-direction driving shaft 304. The X-axis-direction driving motor 302 is composed of, for example, a stepping motor. When receiving an X-axis-direction driving signal from the control device CONT, the X-axis-direction driving motor 302 rotates the X-axis-direction driving shaft 304. When the X-axis-direction driving shaft 304 is rotated, the liquid droplet discharging head 301 is moved in the X-axis direction.

The Y-axis-direction guide shaft 305 is fixed to the table 309 so as not to move thereon. The stage 307 includes a Y-axis-direction driving motor 303. The Y-axis-direction driving motor 303 is composed of, for example, a stepping motor. When receiving a Y-axis-direction driving signal from the control device CONT, the Y-axis-direction driving motor 303 moves the stage 307 in the Y-axis direction.

The control device CONT supplies a liquid droplet discharge control voltage to the liquid droplet discharging head 301. In addition, the control device CONT supplies a driving pulse signal for controlling the movement of the liquid droplet discharging head 301 in the X-axis direction to the X-axis-direction driving motor 302 and a driving pulse signal for controlling the movement of the stage 307 in the Y-axis direction to the Y-axis-direction driving motor 303.

The cleaning mechanism 308 functions to clean the liquid droplet discharging head 301. The cleaning mechanism 308 is provided with a Y-axis-direction driving motor (not shown). The driving of the Y-axis-direction driving motor causes the cleaning mechanism to move along the Y-axis-direction guide shaft 305. The movement of the cleaning mechanism 308 is also controlled by the control device CONT.

The heater 315 is a member for performing a thermal treatment on the substrate P using lamp annealing, and evaporates and dries a solvent contained in the liquid material applied onto the substrate P. The heater 315 is also turned on or off by the control device CONT.

The liquid droplet discharging device IJ moves the liquid droplet discharging head 301 relative to the stage 307 supporting the substrate P to discharge liquid droplets onto the substrate P. In the following description, the X-axis direction and the Y-axis direction perpendicular to the X-axis direction are referred to as a scanning direction and a non-scanning direction, respectively.

Therefore, the discharging nozzles of the liquid droplet discharging head 301 are provided in the Y-axis direction, which is the non-scanning direction, at predetermined intervals. In FIG. 6, the liquid droplet discharging head 301 is arranged perpendicular to the moving direction of the substrate P. However, the liquid droplet discharging head 301 may be arranged so as to intersect the moving direction of the substrate P. In this way, it is possible to adjust pitches between the nozzles by adjusting the arrangement angle of the liquid droplet discharging head 301. In addition, a distance between the substrate P and a nozzle surface may be arbitrarily set.

FIG. 7 is a cross-sectional view of the liquid droplet discharging head 301.

The liquid droplet discharging head 301 is provided with a piezoelectric element 322 which is arranged adjacent to a liquid chamber 321 containing the liquid material (ink for wiring lines). The liquid material is supplied to the liquid chamber 321 through a liquid material supply line 323 including a material tank containing the liquid material.

The piezoelectric element 322 is connected to a driving circuit 324. A voltage is applied to the piezoelectric element 322 through the driving circuit 324 to deform the piezoelectric element 322. Then, the liquid chamber 321 is deformed by the deformation of the piezoelectric element 322, causing the liquid material to be discharged from the nozzles 325.

In this case, the degree of deformation of the piezoelectric element 322 can be controlled by varying the value of a voltage applied. Also, it is possible to control the distortion speed of the piezoelectric element 322 by varying the frequency of the voltage applied. Since the piezoelectric liquid droplet discharging method does not apply heat to the material, it has an advantage that the composition of the material is not affected.

Second Process of Forming Laminated Portion

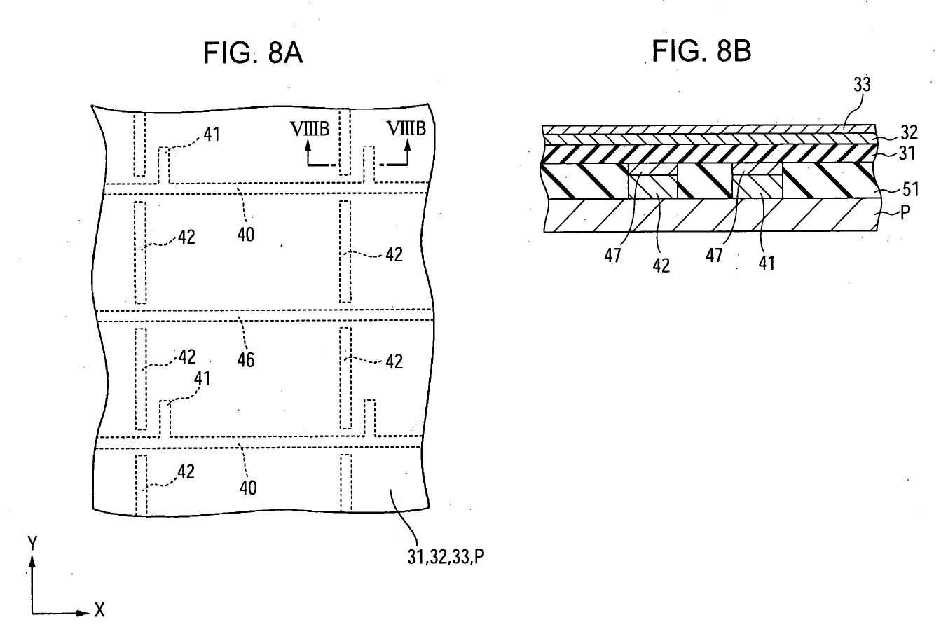

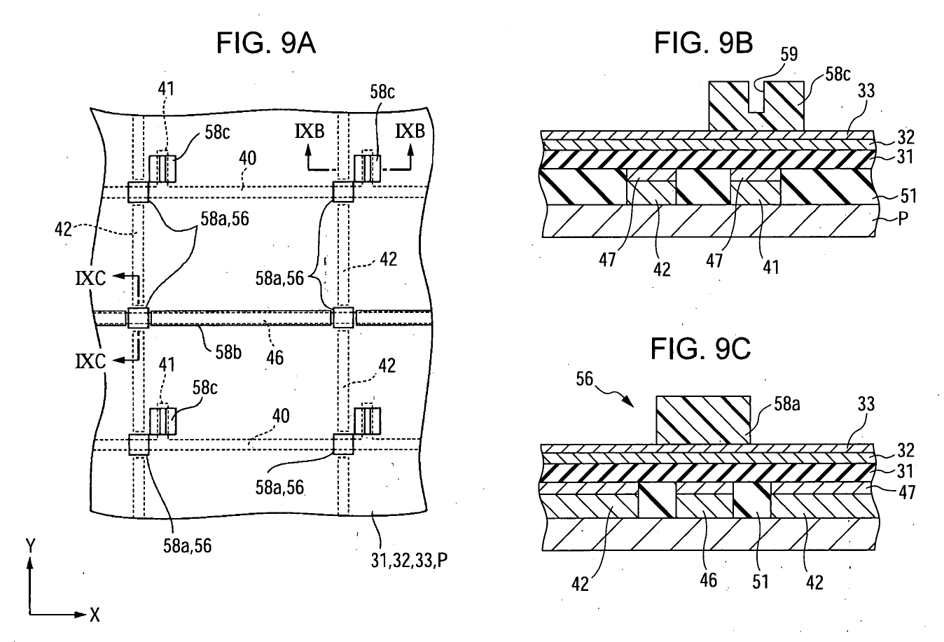

FIGS. 8A to 11C are diagrams illustrating a process of forming a laminated portion, which is a second process. More specifically, FIGS. 8B, 9B, 10B, and 11B are cross-sectional views taken along the lines VIIIB-VIIIB, IXB-IXB, XB-XB, and XIB-XIB of FIGS. 8A, 9B, 10A, and 11A, respectively. FIGS. 9C, 10C, and 11C are cross-sectional views taken along the lines of IXC-IXC, XC-XC, and XIC-XIC of FIGS. 9A, 10A, and 11A.

In the second process, a laminated portion 35 of the insulating film 31 and the semiconductor film (a contact layer 33 and an active layer 32) is formed in a predetermined position on a layer including the banks 51 and the wiring lines having a lattice pattern.

In this process, an additional wiring line layer is formed on the wiring line layer (for example, the gate lines 40) formed in the first process. However, the lyophobic treatment has been performed on the surfaces of the banks 51 for forming the wiring lines in the first process, and thus, when source electrodes are directly formed on the surfaces of the banks 51, ink for forming the electrodes is repelled from the surfaces of the banks 51, making it difficult to form a good film pattern. Thus, in this process, a lyophilic treatment is previously performed on the surfaces of the banks 51 of a lower layer, before, for example, the source electrodes are formed. For example, an ultraviolet radiation process, an O₂ plasma process using oxygen as a raw gas in atmosphere, a heat treatment, or a combination thereof can be used as the lyophilic treatment. The O₂ plasma process is performed by radiating plasma-state oxygen from a plasma discharge electrode onto the substrate P. The O₂ plasma process is performed under the following conditions: for example, a plasma power of 50 W to 1000 W, an oxygen gas flow rate of 50 ml/min to 100 ml/min, a transporting speed of the substrate P with respect to the plasma discharge electrode of 0.5 mm/sec to 10 mm/sec, and a substrate temperature of 70 to 90° C. The heat treatment is performed for 30 to 90 minutes at a temperature of 200° C. to 300° C.

After, the lyophilic treatment is performed on the banks 51, the insulating film 31, the active layer 32, and the contact layer 33 are sequentially formed on the entire surface of the substrate P by a plasma CVD method. More specifically, as shown in FIGS. 8A and 8B, a silicon nitride film, serving as the insulating film 31, an amorphous silicon film, serving as the active layer 32, and an n⁺ silicon film, serving as the contact layer 33, are sequentially formed by varying the raw gas and plasma conditions.

Then, as shown in FIGS. 9A to 9C, resists 58 (58a to 58c) are arranged by a photolithography method at predetermined positions, such as on intersections 56 of the gate lines 40 and the source lines 42, on the gate electrodes, and on the capacitor lines 46.

The resists 58 are formed such that the resists 58a arranged on the intersections 56 do not contact the resists 58b arranged on the capacitor lines 46. In addition, half exposure is performed on the resists 58c arranged on the gate electrodes 41 to form grooves 59, as shown in FIG. 9B.

Successively, etching is performed on the entire surface of the substrate P to remove the contact layer 33 and the active layer 32. Then, etching is performed again to remove the insulating film 31.

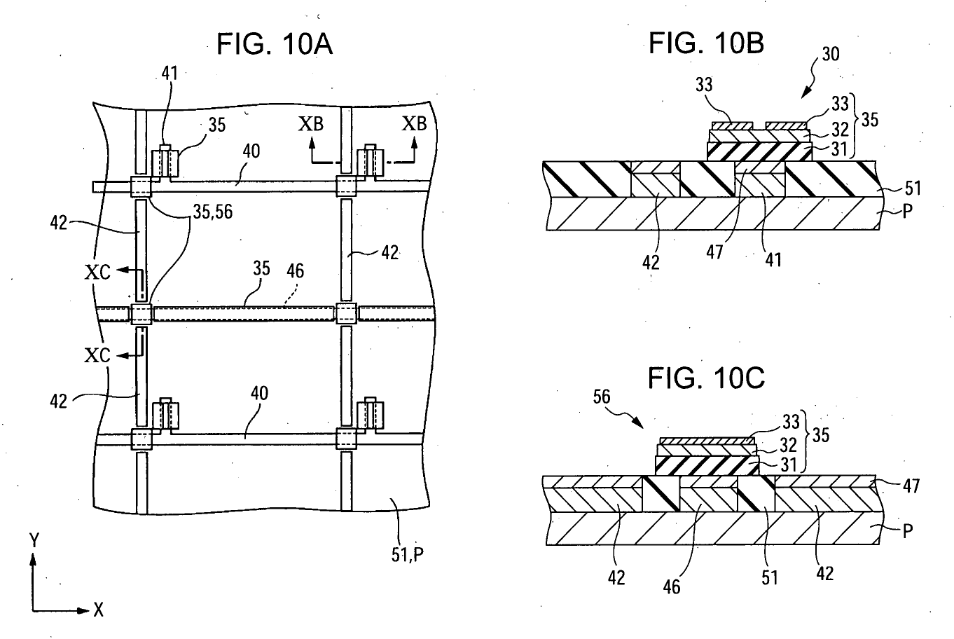

In this way, as shown in FIGS. 10A, 10B, and 10C, the contact layer 33, the active layer 32, and the insulating film 31 are removed from regions other than the predetermined positions where the resists 58 (58a to 58c) are arranged. Meanwhile, the laminated portion 35 of the insulating film 31 and the semiconductor layer (the contact layer 33 and the active layer 32) is formed at the predetermined positions where the resists 58 are arranged.

Further, in the laminated portion 35 formed on the gate electrode 41, since half exposure is performed on the resist 58c to form the groove 59, developing is performed thereon before the etching to form the groove. As shown in FIG. 10B, a portion of the contact layer 33 corresponding to the groove 59 is removed, so that the contact layer is divided into two parts. In this way, the TFT 30 composed of the active layer 32 and the contact layer 33, serving as a switching element, is formed on the gate electrode 41.

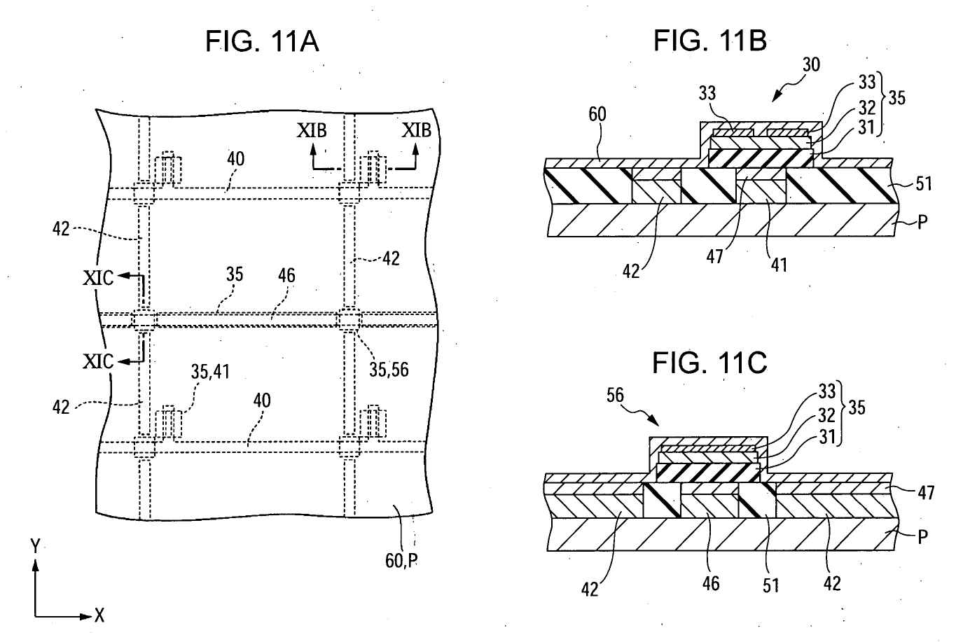

Then, as shown in FIGS. 11A to 11C, a silicon nitride film, serving as a protective film 60 for protecting the contact layer 33, is formed on the entire surface of the substrate P.

In this way, the laminated portion 35 is formed.

Third Process

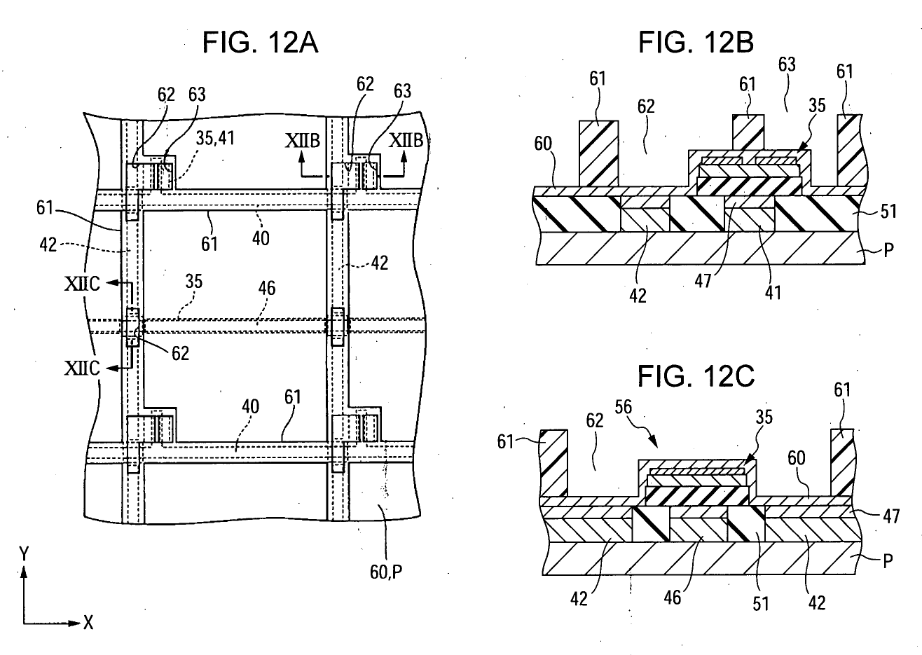

FIGS. 12A to 15C are diagrams illustrating a process of forming, for example, the pixel electrodes 45, which is a third process. More specifically, FIGS. 12B, 13B, 14B, and 15B are cross-sectional views taken along the lines XIIB-XIIB, XIIIB-XIIIB, XIVB-XIVB, and XVB-XVB of FIGS. 12A, 13A, 14A, and 15A, respectively. FIGS. 12C, 13C, 14C, and 15C are cross-sectional views taken along the lines of XIIC-XIIC, XIIIC-XIIIC, XIVC-XIVC, and XVC-XVC of FIGS. 12A, 13A, 14A, and 15A, respectively.

The third process forms the source electrodes 43, the drain electrodes 44, a conductive layer 49, and the pixel electrodes 45.

The source electrodes 43, the drain electrodes 44, and the conductive layer 49 can be formed of the same material as that forming the gate lines 40 and the source lines 42. The pixel electrodes 45 are preferably formed of a transmissive material, such as ITO (indium tin oxide). Similar to the first process, the liquid droplet discharging method is used to form these components.

First, banks 61 are formed by a photolithography method so as to cover the gate lines 40 and the source lines 42. That is, as shown in FIGS. 12A to 12C, the banks 61 having a substantially lattice shape are formed. In addition, openings 62 are formed at intersections of the source lines 42 and the gate lines 40 and intersections of the source lines 42 and the capacitor lines 46, and openings 63 are formed corresponding to the drain regions of the TFTs 30.

As shown in FIG. 12B, the openings 62 and 63 are formed such that a portion of the laminated portion 35 (the TFT 30) formed on the gate electrode 41 is exposed. That is, the bank 61 is formed so as to divide the laminated portion 35 (the TFT 30) into two parts in the X direction.

Similar to the banks 51, the banks 61 are formed of a polymer material, such as an acrylic resin, a polyimide resin, an olefin resin, or a melamine resin. The surfaces of the banks 61 preferably have a lyophobic property. However, in this case, a lyophobic treatment, such as the CF₄ plasma process, is performed on the banks 51, which are an underlayer having a lyophilic property on the surface thereof. Therefore, it is preferable that the banks 61 be formed of a lyophobic material (for example, a fluorine group).

Openings 62 formed by the banks 61 correspond to the forming positions of the conductive layer 49 or the source electrodes 43 connecting the divided source lines 42, and the openings 63 formed in the banks 61 correspond to the forming positions of the drain electrodes 44. In addition, regions surrounded by the banks 61 in the other portions correspond to the forming positions of the pixel electrodes 45. That is, a conductive material is arranged in the openings 62 and 63 of the banks 61 and in the regions surrounded by the banks 61 to form the source electrodes 43, the drain electrodes 44, the pixel electrodes 45, and the conductive layer 49 connecting the divided source lines 42.

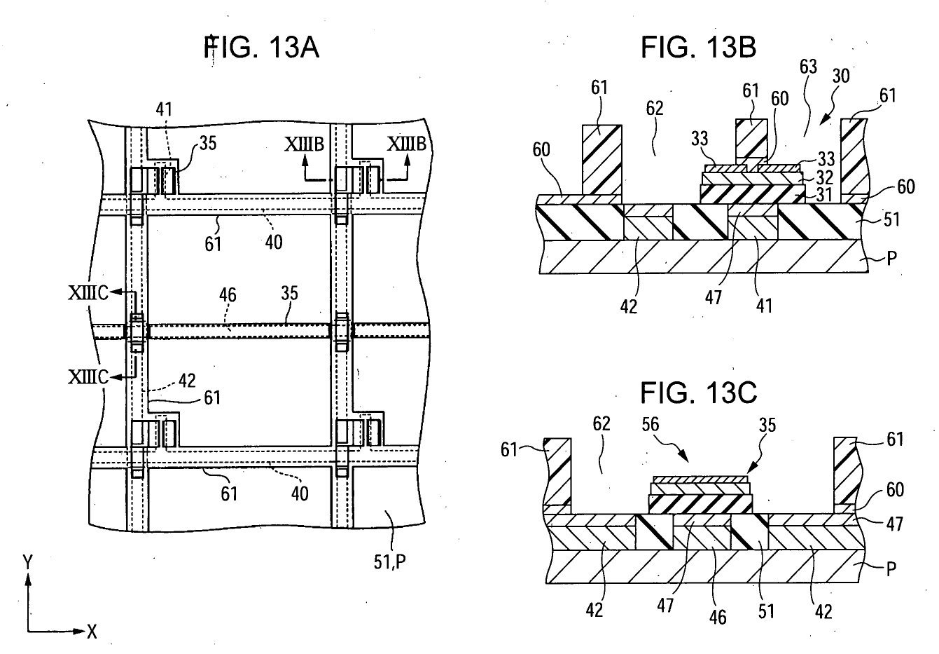

Subsequently, the protective film 60 formed on the entire surface of the substrate p is removed by etching. In this way, as shown in FIGS. 13A to 13C, the protective film 60 formed in the regions where the banks 61 are not arranged is removed. In addition, the metal protective film 47 formed on the wiring lines having a lattice pattern is also removed.

Then, the liquid droplet discharging device IJ discharges, into the openings 62 and 63 of the banks 61, ink for electrodes including a material forming electrodes, such as the source electrodes 43 and the drain electrodes 44. The ink for electrodes may be the same as the ink for wiring lines which is used to form the gate lines 40. After the ink for electrodes is arranged onto the substrate P, a drying process and a baking process are performed, if necessary, to remove the dispersion medium. Electrical contact is ensured between the conductive minute particles by the drying and baking processes, so that a material film is converted into a conductive film.

Further, in the drawings, the source electrode 43 or the drain electrode 44 is formed of a single film. However, these electrodes may be formed in a laminated structure of a plurality of layers. For example, these electrodes can be composed of conductive members each having a three-layer structure of a barrier metal layer, a base layer, and a covering layer. The barrier layer or the covering layer can be formed of one or more metallic materials selected from, for example, Ni (nickel), Ti (titanium), W (tungsten), and Mn (manganese), and the base layer can be formed of one or more metallic materials selected from, for example, Ag (silver), Cu (copper), and Al (aluminum). These layers can be sequentially formed by repeatedly performing the material arranging process and an intermediate drying process.

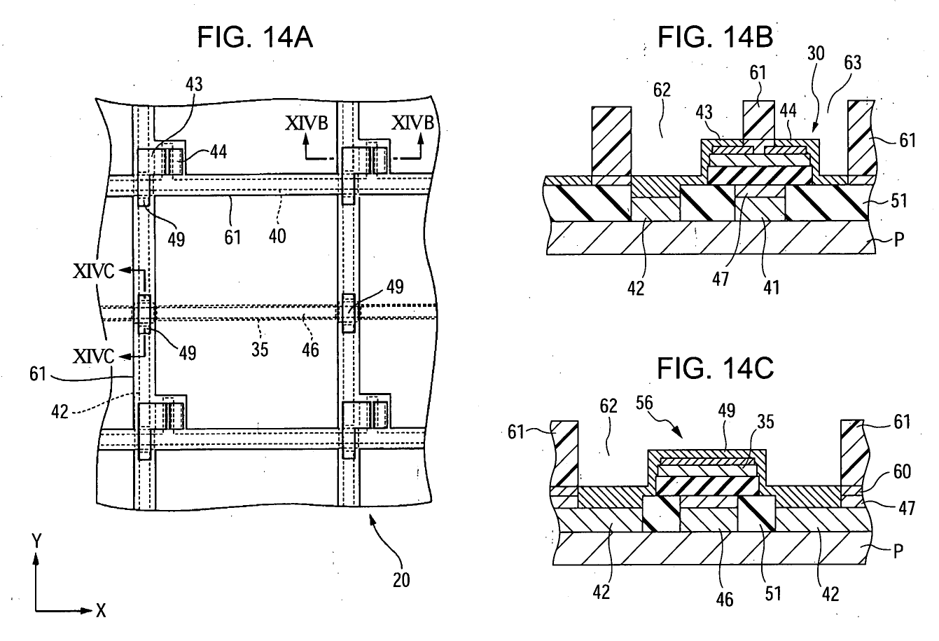

In this way, as shown in FIGS. 14A to 14C, the source lines 43, the drain electrodes 44, and the conductive layer 49 connecting the divided source lines 42 are formed on the substrate P.

Subsequently, the banks 61 positioned at boundaries between the pixel electrodes 45 and the drain electrodes 44 are removed by, for example, laser radiation, and ink for pixel electrodes including a material forming the pixel electrodes 45 is discharged in the regions surrounded by the banks 61. The ink for pixel electrodes is a dispersion liquid obtained by dispersing conductive minute particles, such as ITO particles, into a dispersion medium. After the ink for pixel electrodes is arranged onto the substrate P, a drying process and a baking process are performed, if necessary, to remove the dispersion medium. Electrical contact is ensured between the conductive minute particles by the drying and baking processes, so that a material film is converted into a conductive film.

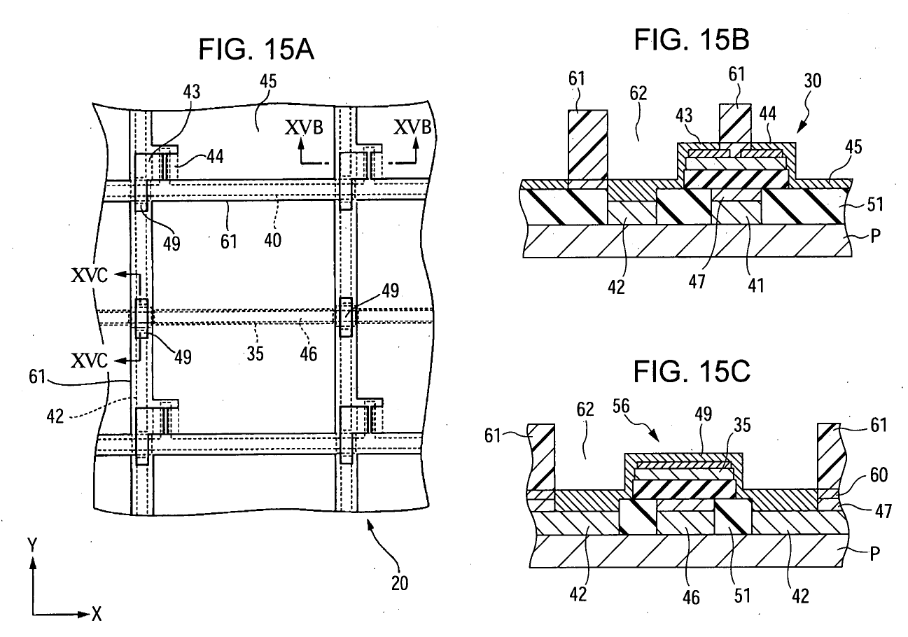

In this way, as shown in FIGS. 15A and 15B, the pixel electrodes 45 electrically connected to the drain electrodes 44 are formed.

Further, in this process, the banks 61 positioned at the boundaries between the pixel electrodes 45 and the drain electrodes 44 are removed by, for example, laser radiation in order to electrically connect the drain electrodes 44 and the pixel electrodes 45, but the invention is not limited to this structure. For example, when half exposure is previously performed on the banks 61 positioned at the boundaries to reduce the thickness thereof, it is possible to discharge the ink for pixel electrodes so as to overlap the drain electrodes 44 without removing the banks 61 positioned at the boundaries.

In this way, the active matrix substrate 20 is manufactured by the above-mentioned processes.

As such, in this embodiment, a lyophilic treatment is performed on the surfaces of the banks 51 formed in the lower layer before the wiring line layer (the source electrodes 43, the drain electrodes 44, and the pixel electrodes 45), which is an upper layer, is formed. This structure makes it possible to improve wettability between the substrate and the banks and thus form a uniform film pattern.

Further, in this embodiment, the method of manufacturing the active matrix substrate 20 includes the first process of forming wiring lines having a lattice pattern on the substrate P, the second process of forming the laminated portion 35, and the third process of forming, for example, the pixel electrodes 45. Therefore, it is possible to combine the drying process with the photolithography process and thus to reduce the number of processes. That is, since the gate lines 40 and the source lines 42 are formed at the same time, it is possible to combine the drying process with the photolithography process and thus to reduce the number of processes by one.

Furthermore, since the laminated portion 35 (the insulating film 31, the active layer 32, and the contact layer 33) formed on the capacitor line 46 is divided into two parts so as not to contact the laminated portion 35 formed on the intersection 56, it is possible to prevent a current passing through the source line 42 from flowing to the laminated portion 35 formed on the capacitor line 46.

That is, the contact layer 33 of the laminated portion 35 is a conductive film, and the conductive layer 49 for connecting the source lines 42 is formed on the laminated portion 35 (the contact layer 33) on the intersection 56. Therefore, a current passes through the contact layer 33 as well as the source lines 42. Thus, when the laminated portion 35 formed on the capacitor line 46 contacts the laminated portion 35 formed on the intersection 56, a current passing through the source line 42 flows to the laminated portion 35 formed on the capacitor line 46.

Accordingly, the active matrix substrate 20 of this embodiment can solve this problem and thus exhibit a desired performance.

Moreover, in this embodiment, the source line 42 is divided at the intersection 56. However, the gate line 40 or the capacitor line 46 may be divided at the intersection 56. Since the capacitor line 46 has a larger effect on display than the source line 42 has, it is preferable to divide the source line 42 in order to obtain a high display quality.

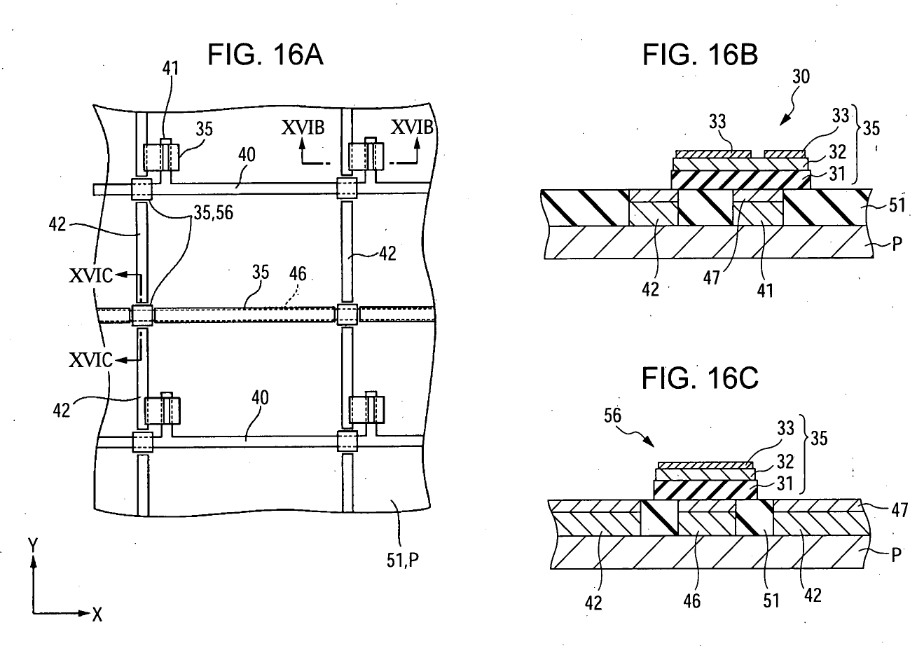

Further, a preferred embodiment of the active matrix substrate has been described above. However, the shapes of the components and combinations thereof are limited to the embodiment. For example, the shape and arrangement of the laminated portion 35 shown in FIGS. 10A to 10C can be substituted for the shape and arrangement of the laminated portion 35 shown in FIGS. 16A to 16C. In this case, since the source region and the source line 43 are arranged adjacent to each other, it is possible to reduce the area where the source electrode 43 is formed and to manufacture a high-performance active matrix substrate.

Electro-Optical Device

Next, a liquid crystal display device 100, which is an example of an electro-optical device using the active matrix substrate 20, will be described.

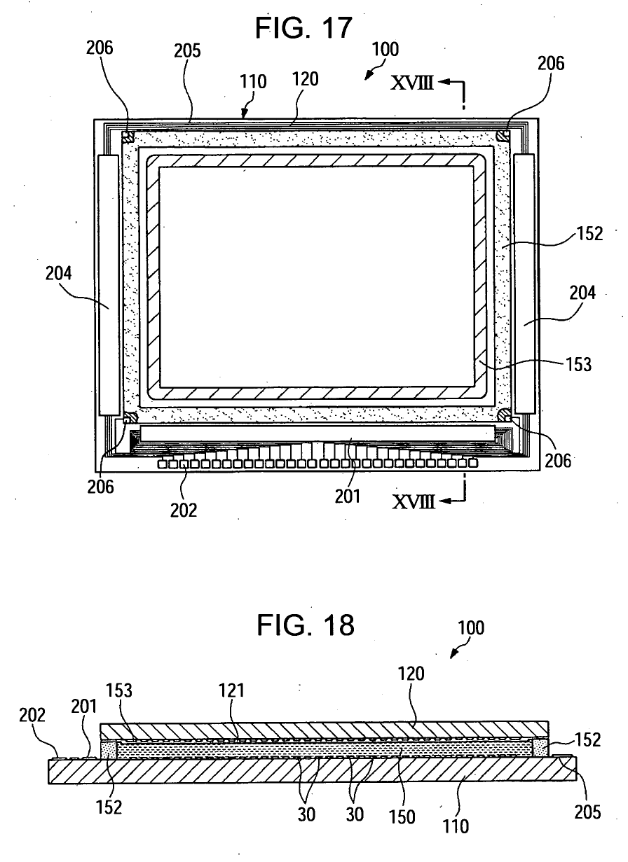

FIG. 17 is a plan view of the liquid crystal display device 100, as viewed from a counter substrate, and FIG. 18 is a cross-sectional view taken along the line XVIII-XVIII of FIG. 17.

In the drawings used for the following description, a scale of each layer or member is adjusted in order to have a recognizable size.

As shown in FIGS. 17 and 18, the liquid crystal display device (electro-optical device) 100 includes a TFT array substrate 110 including the active matrix substrate 20, a counter substrate 120, and a sealing material 152 for bonding the substrates, which is a light-curable sealing material. Liquid crystal 150 is injected and held in a region defined by the sealing material 152. The sealing material 152 is formed in a closed-frame shape on the inner surfaces of the substrates, without a liquid crystal injection port and marks of being sealed by the sealing material.

A peripheral partition 153 formed of a light-shielding material is formed inside a region where the sealing material 152 is formed. In a region outside the sealing material 152, a data line driving circuit 201 and mounting terminals 202 are formed along one side of the TFT array substrate 110, and scanning line driving circuits 204 are formed along two sides adjacent to the one side. A plurality of wiring lines 205 for connecting the scanning line driving circuits 204 provided at both sides of the image display region is provided along the remaining side of the TFT array substrate 110. In addition, conductive members 206 for electrically conducting the TFT array substrate 110 and the counter substrate 120 are provided at least one of the corners of the counter substrate 120.

Further, instead of forming the data line driving circuit 201 and the scanning line driving circuits 204 on the TFT array substrate 110, for example, a TAB (tape automated bonding) substrate having a driving LSI mounted thereon may be electrically and mechanically connected to a group of terminals formed in the periphery of the TFT array substrate 110 through an anisotropic conductive film.

In addition, the liquid crystal display device 100 may include, for example, a retardation plate and a polarizing plate arranged in a predetermined direction, according to the type of the liquid crystal 150 used, that is, according to operation modes, such as a TN (Twisted Nematic) mode, a C-TN method, a VA format, and an IPS format, or display modes, such as a normally white mode and a normally black mode. However, these plates are not shown in this embodiment.

Further, when the liquid crystal display device 100 is used for color display, for example, red (R), green (G), and blue (B) color filters are formed together with a protective film therefor in a region of the counter substrate 120 opposite to each pixel electrode, which will be described later, of the TFT array substrate 110.

Since the active matrix substrate 20 manufactured by the above-mentioned method is used for the liquid crystal display device 100, the liquid crystal display device 100 can display a high-quality image.

In this embodiment, the film pattern forming method of the invention is used to form the wiring structure of the liquid crystal display device, but the invention is not limited thereto. For example, the invention may be applied to a structure in which color filters are formed on an active matrix substrate or a counter substrate.

The active matrix substrate can be applied to electro-optical devices other than the liquid crystal display device, such as an organic EL (electroluminescent) display device. The organic EL device is a device in which a film containing inorganic and organic fluorescent compounds is interposed between a cathode and an anode; electrons and holes are injected into the film to excite it, thereby generating excitons; and light (luminescence and phosphorescence) is emitted when these excitons are recoupled. In addition, a self-emitting full color EL device can be manufactured by discharging, as ink, materials emitting red, green, and blue colored light components, among fluorescent materials used for the organic EL display device, that is, a light-emitting layer forming material and materials forming hole injection/electron transport layers, on the substrate having the TFTs 30 thereon, and then by patterning the formed films. The scope of the electro-optical device in the invention covers the above-described organic EL device. In the organic EL display device, the film pattern forming method of the invention may be used to form the hole injection/transport layer forming material and the light-emitting layer forming material.

Further, the active matrix substrate 20 can be applied to a PDP (plasma display panel) and a surface-conduction-type electron emitting device in which electrons are emitted by passing a current parallel to the surface of a thin film which is formed on a substrate in a small area.

Electronic Apparatus

Next, examples of an electronic apparatus of the invention will be described.

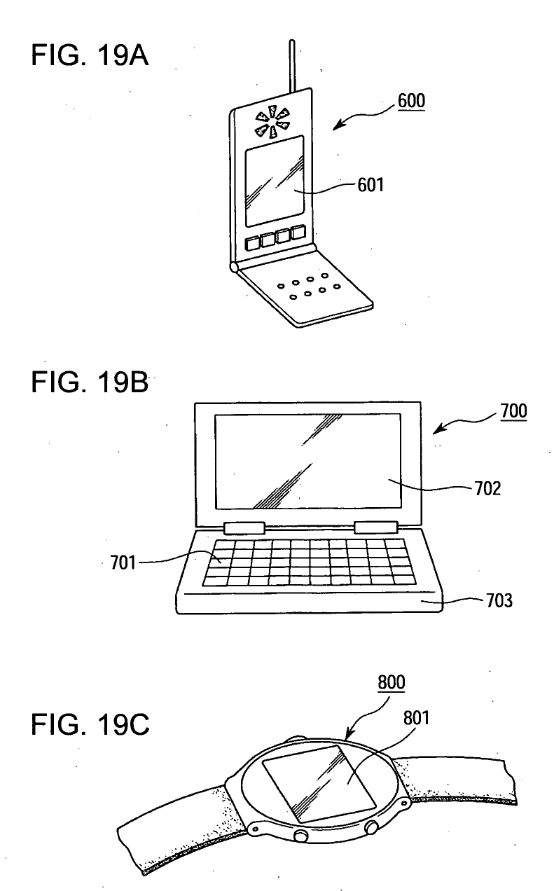

FIG. 19A is a perspective view illustrating an example of a mobile phone. In FIG. 19A, reference numeral 600 denotes a mobile phone body, and reference numeral 601 denotes a display unit including the liquid crystal display device 100 according to the above-described embodiment.

FIG. 19B is a perspective view illustrating an example of a portable information processing apparatus, such as a word processor or a personal computer. In FIG. 19B, reference numeral 700 denotes an information processing apparatus, and reference numeral 701 denotes an input unit, such as a keyboard. Reference numeral 703 denotes an information processing apparatus body, and reference numeral 702 denotes a display unit including the liquid crystal display device 100 according to the above-described embodiment.

FIG. 19C is a perspective view illustrating an example of an electronic wristwatch. In FIG. 19C, reference numeral 800 denotes a watch body, and reference numeral 801 denotes a display unit including the liquid crystal display device 100 according to the above-described embodiment.

The electronic apparatuses shown in FIGS. 19A to 19C can have high quality and high performance since the electronic apparatuses are provided with the liquid crystal display device 100 according to the above-described embodiment.

Further, the invention can be applied to a large liquid crystal display panel, such as a television or a monitor.

In the above-described embodiment, the electronic apparatuses are provided with the liquid crystal display device 100. However, the electronic apparatuses may be provided with other electro-optical devices, such as an organic EL device and a plasma display device.

Although the preferred embodiments of the invention have been described above with reference to the accompanying drawings, the invention is not limited thereto. It should be understood that the shapes or combinations of the above-described components are just illustrative, but various modifications and changes thereof can be made without departing from the scope and spirit of the invention.

What is claimed is:

1. A method of forming a film pattern by arranging a functional liquid on a substrate, comprising:
forming first banks having a lyophobic property on surfaces thereof;
arranging a first functional liquid in regions partitioned by the first banks;
baking the first functional liquid;
forming second banks on the first banks; and
arranging a second functional liquid in regions partitioned by the second banks,
wherein a lyophilic treatment is performed on the surfaces of the first banks between the arranging of the first functional liquid and the forming of the second banks.

2. The method of forming a film pattern according to claim 1,
wherein the lyophilic treatment includes radiating plasma onto the first banks under an atmosphere containing oxygen.

3. The method of forming a film pattern according to claim 1,
wherein the lyophilic treatment includes radiating ultraviolet rays onto the first banks.

4. The method of forming a film pattern according to claim 1,
wherein the lyophilic treatment includes a heat treatment on the first banks.

5. The method of forming a film pattern according to claim 1,
wherein the functional liquids have conductivity by a thermal or optical treatment.

6. A method of manufacturing a device, comprising:
forming a film pattern on a substrate by using the method of forming a film pattern according to claim 1.

7. An electro-optical device comprising a device manufactured by the device manufacturing method according to claim 6.

8. An electronic apparatus comprising the electro-optical device according to claim 7.
